(19) United States
(12) Patent Application Publication
(10) Pub. No.: US 2022/0200984 A1
(43) Pub. Date: Jun. 23, 2022

(54) PROVISIONING DATA ON A DEVICE

(71) Applicant: ARM LIMITED, Cambridge (GB)

(72) Inventors: Yongbeom PAK, Oulu (GB); Enrique CORDERO BLANCO, Oulu (GB)

(21) Appl. No.: 17/594,231

(22) PCT Filed: Feb. 21, 2020
(86) PCT No.: PCT/GB2020/050424

§ 371 Date: Oct. 7, 2021

(30) Foreign Application Priority Data
Apr. 10, 2019 (GB) 1905064.0

(51) Int. Cl. H04L 9/40; H04L 9/32

(52) U.S. Cl. CPC H04L 63/0823; H04L 9/3213; H04L 63/0876

(57) ABSTRACT

There is disclosed a computer implemented method of bootstrapping a device by a bootstrap server, the method comprising: receiving, at the bootstrap server, credential data comprising a token and certificate data; verifying, with the bootstrap server, whether the token is legitimate; verifying, with the bootstrap server, whether the certificate data is trusted; responsive to verifying that the token is legitimate and that the certificate data is trusted providing, from the bootstrap server to the device, resource credential data to enable the device to authenticate with a first server.

The present techniques generally relate to a bootstrap mechanism for endpoint devices.

There are ever increasing numbers of devices within the home, other buildings or the outdoor environment that have processing and communication capabilities which allow them to communicate with other entities (e.g. devices, servers, services etc.) within the same network or on a different network (e.g. on the internet) to access servers or services as part of the “Internet of Things” (IoT)

For example, a temperature device in a home may gather sensed data and push the sensed data to a remote service (such as an application running in ‘the cloud’). The temperature device may then be controlled remotely by the remote service via received command data.

In other examples, a pollution monitoring device in a factory may comprise a sensor to gather information from various chemical sensors and arrange maintenance based on the gathered information; whilst a healthcare provider may use devices comprising sensors, such as a heart rate monitor to track the health of patients while they are at home.

Data is generally transmitted between devices and other entities using machine-to-machine (M2M) communication techniques, and the present applicant has recognised the need for improved techniques for provisioning data on devices.

According to a first technique there is provided a computer implemented method comprising a computer implemented method of bootstrapping a device by a bootstrap server, the method comprising: receiving, at the bootstrap server, credential data comprising a token and certificate data; verifying, with the bootstrap server, whether the token is legitimate; verifying, with the bootstrap server, whether the certificate data is trusted; responsive to verifying that the token is legitimate and that the certificate data is trusted providing, from the bootstrap server to the device, resource credential data to enable the device to authenticate with a first server.

According to a further technique there is provided a computer implemented method of bootstrapping a device comprising: obtaining, at the device from a device management platform, credential data comprising a token having a device account identifier; providing, from the device to the bootstrap server, the token to enable the bootstrap server to determine the legitimacy of the token; providing, from the device to the bootstrap server, certificate data to enable the bootstrap server to determine whether an associated certificate has a chain of trust to a trusted entity; receiving, at the device from the bootstrap server, resource credential data to enable the device to connect with a first server, the resource credential data based on or in response to the token.

According to a further technique there is provided a computer implemented method of provisioning a device account identifier to a device, the method comprising: receiving, at a device management platform, a certificate associated with a device account, the certificate having a chain of trust to a trusted party; generating, at the device management platform, one or more tokens; associating a first token of the one or more tokens with the device account; provisioning, from the device management platform to the device; the first token; receiving, at a bootstrap server of the device management platform, a bootstrap request comprising credential data including the first token; verifying the legitimacy of the first token at the device management platform; responsive to a successful verification, providing, from the bootstrap server to the device, resource credential data to enable the device to authenticate with a first server.

The techniques are diagrammatically illustrated, by way of example, in the accompanying drawings, in which:

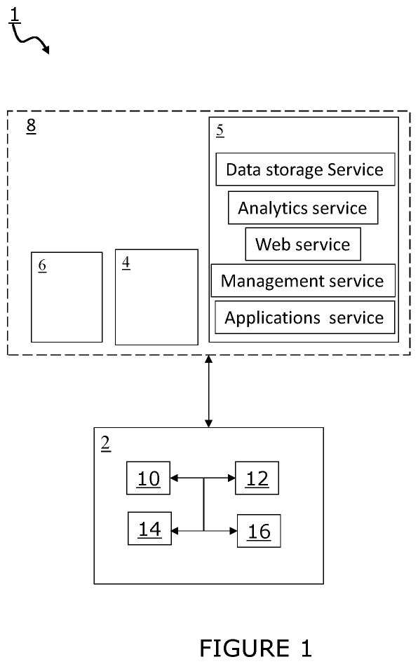

FIG. 1 shows an example deployment scenario for a device according to the present techniques;

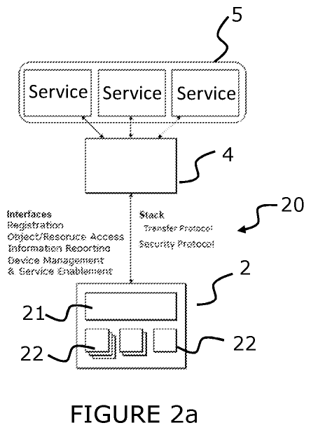

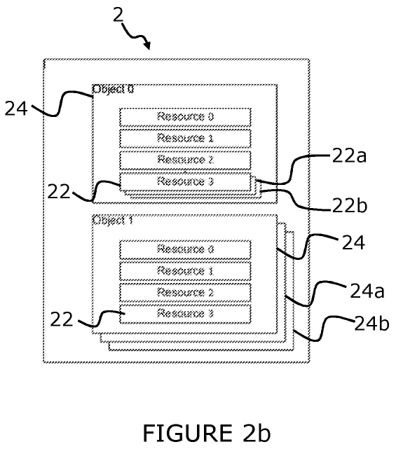

FIG. 2a shows an example architecture depicting a client-server relationship between the device of FIG. 1 and a server;

FIG. 2b shows a schematic diagram of an object model on the device of FIG. 1;

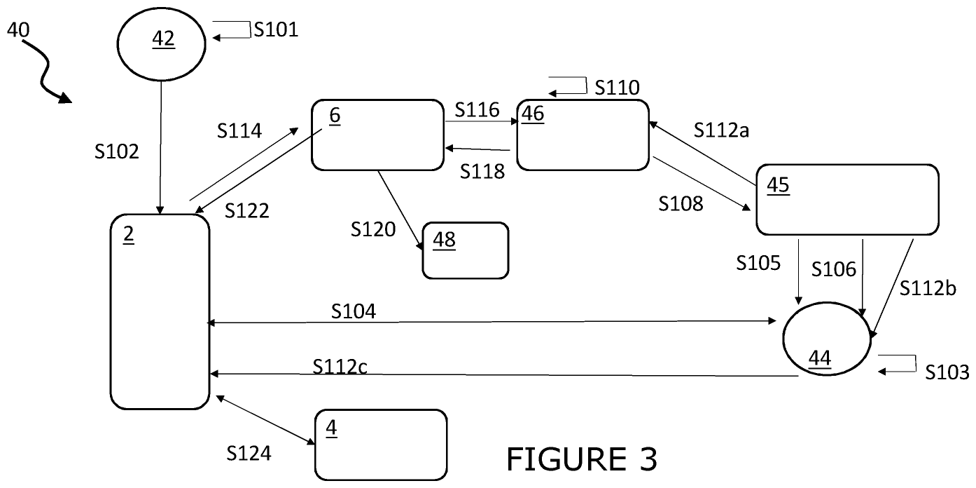

FIG. 3 illustratively shows an example of provisioning credential data to the device;

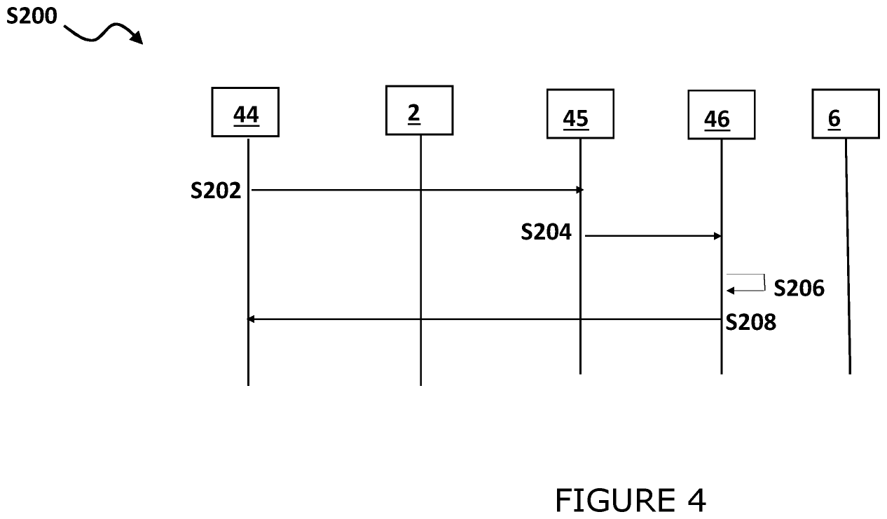

FIG. 4 illustratively show an example process in which device requests that one or more tokens are created;

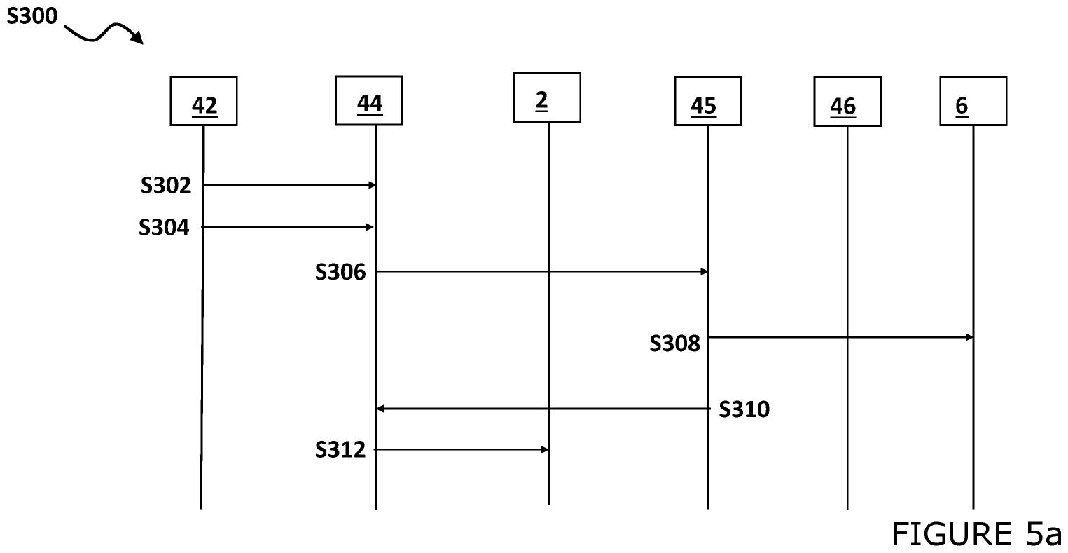

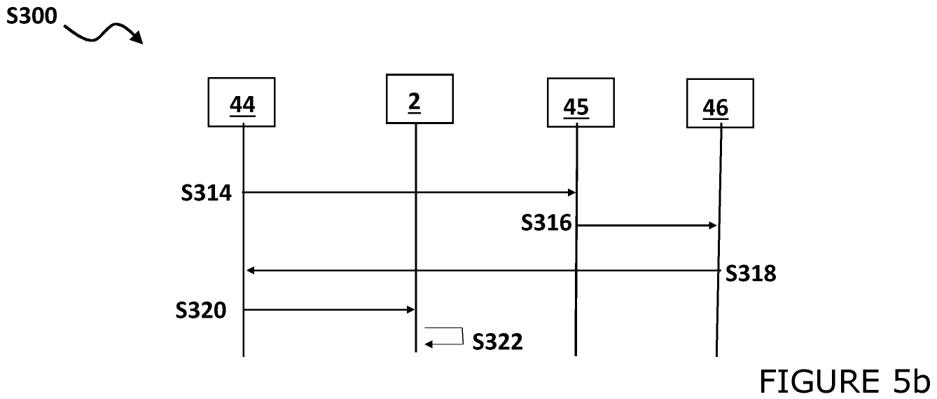

FIGS. 5a & 5b illustratively show an example process in which the device is provisioned with credential data to perform a bootstrap process; and

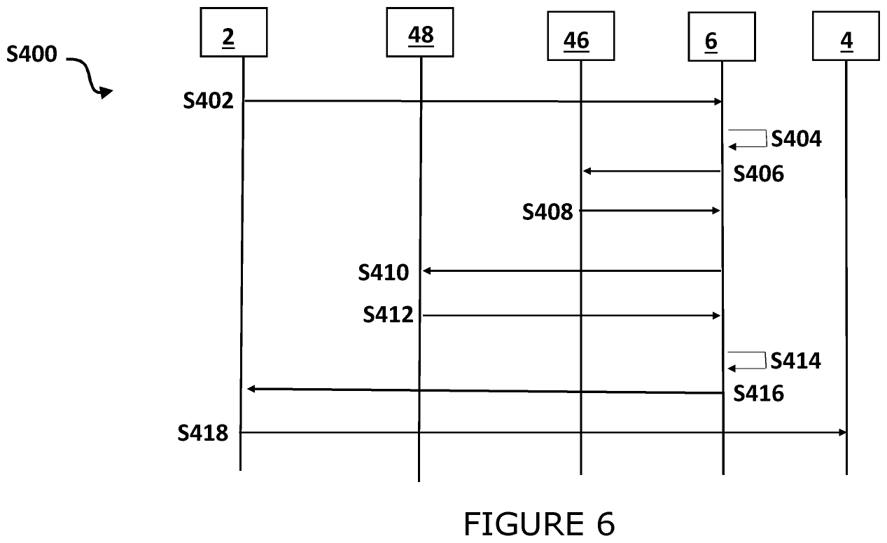

FIG. 6 illustratively shows an example process in which the device is provisioned with credential data to enable the device to authenticate with a resource server.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

FIG. 1 shows a deployment scenario 1 for a device 2 according to the present techniques.

Device 2 may be a computer terminal, a laptop, a tablet or mobile-phone, or may, for example, be a lightweight M2M (LwM2M) device running a LwM2M client. Device 2 can be used to provide smart functionality for streetlights, electric meters, temperature sensors, building automation, healthcare, and a range of other market segments as part of the IoT. It will be appreciated that the examples of market segments listed above are for illustrative purposes only and the claims are not limited in this respect.

Device 2 is operable to communicate with one or more servers and/or services.

As described herein a server (depicted in FIG. 1 as “server 4”, “server 6”) may be a single computing device or software running on a computing device. However, the claims are not limited in this respect and the server may comprise a plurality of interconnected computing devices (or software running on a plurality of interconnected devices), whereby the plurality of interconnected computing devices may be distributed over one or more public and/or private networks

In the present figures, server 4 (hereafter “resource server”) may, for example, be a LwM2M server, an application server, an edge server, a computer terminal, a laptop, a tablet or mobile-phone, or an application hosted on a computing device, and which provides deployment of one or more services (depicted in FIG. 1 as “service 5”). Such services may include one or more of: web service(s); data storage service; analytics service(s), management service(s) and application service(s), although this list is not exhaustive.

In the present figures server 6 comprises a bootstrap server which is used to provision resources at the device 2. In embodiments, bootstrap server 6 may be any type of server or remote machine and may not necessarily be a dedicated bootstrap server. Generally speaking the bootstrap server 6 is any means suitable to perform a bootstrap process with the device 2 (e.g. machine, hardware, technology, server, software, etc.).

In the present examples, the resource server 4, bootstrap server 6 and/or services 5 are depicted as being part of a device management platform 8, such as the Pelion™ device management platform from Arm®, Cambridge, UK.

The device 2 comprises communication circuitry 10 for communicating with the one or more servers 4, 6 and/or services 5.

The communication circuitry 10 may use wireless communication such as, for example, one or more of: Wi-Fi; short range communication such as radio frequency communication (RFID); near field communication (NFC); communications used in wireless technologies such as Bluetooth®, Bluetooth Low Energy (BLE); cellular communications such as 3G or 4G; and the communication circuitry 10 may also use wired communication such as a fibre optic or metal cable. The communication circuitry 10 could also use two or more different forms of communication, such as several of the examples given above in combination.

It will be appreciated that the device 2 could also use any suitable protocols for communications including one or more of: IPv6, IPv6 over Low Power Wireless Standard (6LoWPAN®), Constrained Application Protocol (CoAP), Message Queuing Telemetry Transport (MQTT), Representational state transfer (REST), HTTP, WebSocket, ZigBee®, Thread® although it will be appreciated that these are examples of suitable protocols.

As an illustrative example, CoAP defines the message header, request/response codes, message options and retransmission mechanisms, such as, for example, RESTful Application Programming Interfaces (APIs) on resource-constrained devices and supports the methods of GET, POST, PUT, DELETE, which can be mapped to methods of the HTTP protocol.

M2M communications are typically required to be secure to reduce the risk that malicious third parties gain access to the data, or to limit the access to data, by devices, servers or services. The device may use one or more security protocols to establish a communications path or channel for providing secure communications between entities. Exemplary security protocols may, for example, comprise Transport Layer Security (TLS) and Datagram Transport Layer Security (DTLS), whereby TLS/DTLS may be used to establish a secure channel between the device 2 and resource server 4 whereby TLS/DTLS include establishing communications using, certificates (e.g. X.509 certificates) and both pre-shared key and public key technology. The data (e.g. credential data) protected by TLS/DTLS may be encoded as plain text, binary TLV, JSON, CBOR, or any other suitable data exchange format.

The device 2 further comprises processing circuitry 12 for controlling various processing operations performed by the device 2.

The device 2 may further comprise input/output (I/O) circuitry 14, such that the device 2 can receive inputs (e.g. user inputs, sensor inputs, measurement inputs etc.) and or generate outputs (e.g. audio/visual/control commands etc.).

The device 2 further comprises storage circuitry 16 for storing resources, such as credential data, whereby the storage circuitry 16 may comprise volatile and/or non-volatile memory.

Such credential data may include one or more of: certificates, cryptographic keys (e.g. shared symmetric keys, public keys, private keys), identifiers (e.g. direct or indirect identifiers) whereby such credential data may be used by the device to authenticate (e.g. connect, establish secure communications, register, enroll etc.) with one or more remote entities (e.g. a bootstrap server/server/services).

FIG. 2a illustratively shows an example architecture 20 which illustrates a client-server relationship between the device 2 and resource server 4. FIG. 2b illustratively shows a schematic diagram of an object model of device 2.

In embodiments, the resource server 4 may be a LwM2M server, such that the resource server 4 and client device 2 communicate using suitable protocols, such as those in compliance with the Open Mobile Alliance (OMA) LWM2M specification although the claims are not limited in this respect.

The client device 2 comprises client 21 which may be integrated as a software library or a built-in function of a module and which is used in communications with the resource server 4. The client 21 may be an LwM2M client.

Logical interfaces may be defined between the client 21 and resource server 4, and three logical interfaces are depicted in FIG. 2, namely:
‘Client Registration’ interface may be used to perform and maintain registration with one or more LwM2M servers and de-register from one or more LwM2M servers.
‘Device management and service enablement’ interface may be used by one or more servers to access object(s), object instances and resources available at the client device 2.
‘Information Reporting’ interface may be used to enable one or more servers to observe any changes in a resource on client device 2, and for receiving notifications when new values are available.

This list of logical interfaces is exemplary only and additional, or alternative, logical interfaces between the client 21 and resource server 4 may be provided, for example, in accordance with the OMA LwM2M specification.

The device 2 comprises various resources 22, which can be read, written, executed and/or accessed by the resource server 4 or one or more further servers/services.

As an illustrative example, a resource 22 may comprise a value (e.g. generated by circuitry on the device). A web application may, via resource server 4, request the value from the client device 2 (e.g. with a REPORT request), whereby the requested value is read and reported back to the web application by the resource server 4.

As a further illustrative example, a resource 22 may comprise credential data provisioned at manufacture (e.g. during a factory provisioning process) or during a communication session with a bootstrap server, and subsequently used to register with the resource server 4.

As depicted in FIG. 2b, the resources 22 may be further logically organized into objects 24, whereby each device 2 can have any number of resources, each of which is associated with a respective object 24.

A set of objects on client device 2 may include, for example:
A ‘security object’ to handle security aspects between the client device 2 and one or more servers;
A ‘server object’ to define data and functions related to a server;
An ‘access control object’ to define for each of one or more permitted servers the access rights the one or more servers have for each object on the client device 2;
A ‘device object’ to detail resources on the client device 2. As an example, the device object may detail device information such as manufacturer, model, power information, free memory and error information;
A ‘connectivity monitoring object’ to group together resources on the client device 2 that assist in monitoring the status of a network connection;
A ‘firmware update object’ enables management of firmware which is to be updated, whereby the object includes installing firmware, updating firmware, and performing actions after updating firmware;
A ‘location object’ to group those resources that provide information about the current location of the client device 2;
A ‘connection statistics object’ to group together resources on the client device 2 that hold statistical information about an existing network connection.

In embodiments device 2 may have one or more instances of an object, three of which are depicted as 24, 24a and 24b in FIG. 2b. As an illustrative example, a temperature sensor device may comprise two or more temperature sensors, and the client device 2 may comprise a different device object instance for each temperature sensor.

In embodiments a resource may also comprise one or more resource instances which are depicted as 22, 22a, 22b in FIG. 2b.

In embodiments the objects, object instances, resources and resource instances can be read, written or executed and accessed with, for example URIs:
/{Object ID}/{Object Instance]/[Resource ID} e.g. /3/0/1.

One or more of the objects, object instances, resources and resource instances may be provisioned, for example, at manufacture (e.g. during a factory provisioning process) or by a bootstrap server 6.

On registration with a resource server 4 the device 2 is assigned or bound to an account (hereafter “device account”) at the device management platform and is required to present a device account identifier when communicating with a server (e.g. bootstrap server or resource server), so that the server can determine which of the one or more services 5 at the device management platform that device 2 is authorised to access.

In known techniques, the device account identifier is provisioned on the device at manufacture before leaving the factory, such that when powered on for the first time the device can present the device account identifier to a bootstrap server, which can provision resource credentials based on or in response to the device account identifier, whereby the resource credentials enable the device to authenticate with a resource server at the device management platform and access the one or more services authorised for that account.

Thus, for known techniques a device manufacturer, will for every device it manufacturers, have knowledge of which device account at the device management platform each device is to be assigned to, and will provision a corresponding device account identifier thereto. Such functionality provides operational burdens on the manufacturer.

Therefore, there is a requirement for a bootstrapping process in which the device can be provided with a device account identifier in a secure manner post-manufacture.

FIG. 3 schematically shows a block diagram of a system 40 in which a device 2 obtains credential data comprising bootstrap data to authenticate with a bootstrap server 6 and to obtain further credential data to authenticate with resource server 4 and access one or more services.

At S101, a first party 42, which may be a manufacturer (hereafter “OEM”), creates a device 2 and at S102 the device 2 is subsequently obtained by a second party 44 having ownership rights for the device. In embodiments the second party 44 may be an administrator of a device management platform at which the device 2 is to access a service; a service provider providing the device 2 to end users; or the end users of the device 2. In the present description the second party 44 is hereafter referred to as “device owner”.

The device 2 obtained by the device owner at S102 is not provisioned with the credential data necessary for the device to be able to access one or more services at the device management platform. For example, the device 2 may comprise some credential data but may not comprise a device account identifier.

Thus, when the device owner obtains the device, they must perform various steps to obtain the credential data required to access one or more services at the device management platform.

At S103, the device owner obtains instructions to enable the device owner to obtain such credential data. Such instructions may be provided as part of packaging or a manual accompanying the device 2 or sent to the device owner as a hyperlink on obtaining the device 2, or the instructions may be provided on the device itself (e.g. printed) or whereby the device owner may scan a barcode (e.g. a QR code), near field communications (NFC) tag, or a radio frequency identification code (RFID) code on the device to obtain the instructions.

The instructions provide details or information on how the device owner is to obtain a token or token data (hereafter “token”) and an OEM certificate authority (CA) certificate (hereafter OEM certificate) having a chain of trust to a root authority. In the present illustrative example, the root authority is a party or entity trusted by the device management platform.

At S104 the device owner obtains the OEM certificate in accordance with the instructions. In an illustrative example the device owner may communicate with the OEM (e.g. via a web service) to obtain the OEM certificate. In another illustrative embodiment the OEM certificate may be pre-provisioned on the device 2 when received by the device owner.

At S105, the device owner uploads the OEM certificate to the device management platform via the portal 45, whereby the OEM certificate is registered with the device management platform as a trusted CA and may be used by one or more servers or services at the device management platform to verify certificate data presented by the device 2. The device owner may upload the OEM certificate via a device management platform portal 45 (hereafter “portal” 45). As will be appreciated the device owner may log into its device account via the portal 45 using, for example, an application (e.g. web application) on an associated computing device.

The portal 45 may comprise an application programming interface (API) gateway (GW), which may be a representational state transfer (REST) API, to provide communications between the device owner and the device management platform (e.g. servers/services thereat).

In embodiments the portal 45 may manage the storage and distribution of credential data (e.g. device account identifiers, certificates, etc.) between the device owner and different services/services at the device management platform. In an illustrative example the portal 45 may provide the OEM certificate uploaded by the device owner to the bootstrap server 6 so that that bootstrap server 6 can determine whether the certificate presented by the device 2 has a chain of trust to the root authority and can therefore be trusted.

The owner then provisions OEM certificate data associated with the OEM certificate on the device. The OEM certificate data may comprise the certificate itself or a fingerprint of the OEM certificate, whereby the fingerprint may be calculated using SHA256 hash of DER (Distinguished encoding rules) format of the certificate. Either way, a server can use the certificate data presented by the device 2 to determine whether the OEM certificate can be trusted. A certificate fingerprint enables a server presented with the certificate data to identify the certificate corresponding to the certificate fingerprint. Such a certificate fingerprint may comprise a hash value.

As will be appreciated, the OEM certificate provides a chain of trust between the OEM and a root authority and is useful to verify that the manufacturer of the device is a trusted entity. However, many devices may be provisioned with the same OEM certificate, so the OEM certificate data cannot definitively be used to prove that the device itself can be trusted.

In the present techniques the token is used to demonstrate that the device is to be trusted. The token may comprise one or more streams of data (e.g. a binary data). Additionally, or alternatively, the token may comprise one or more files, whereby the data is stored in the one more files.

At S106, the device owner 44 requests, via portal 45, that one or more tokens are generated at the device management platform. At S108, the request is forwarded to token service 46 and at S110 the token service 46 generates one or more tokens.

The token may comprise a token identifier (e.g. a Universally Unique Identifier (UUID)) to uniquely identify the token.

Each token includes a device account identifier with which the token is associated to enable another server or service determine whether the token is legitimate.

The token comprises authorisation data to further enable another server or service determine whether the token is legitimate. As an illustrative example, the authorisation data may comprise a cryptographic signature in the token. As a further illustrative example, some or all of the data in the token may be encrypted using a cryptographic key, such that the encrypted data may be seen as the authorisation data. A server or service receiving the token can then verify the legitimacy of the token by verifying the signature and/or decrypting the encrypted data.

The token may further comprise a bootstrap identifier to enable the device 2 locate the bootstrap server (e.g. a bootstrap server URI).

The token may also include device data to provide information on one or more device resources and/or information relating to one more resource servers with which the device 2 is to authenticate with as will be described in further detail below.

The token service 46 comprises a database to store information relating to the tokens. Tokens in the database may be indexed by the token identifier, and the database may include details of all data in each token and the cryptographic keys used to encrypt/sign data. The token service 46 may store a record or log of all actions taken in respect of each token therein. In an illustrative example such a record or log may include a timestamp of the time/date the token was generated, an identifier identifying the party requesting the generation of the token; an identifier identifying the party to which the token(s) is issued. Such a record or log provides an audit record for each token.

The token service can configure data in each token with input from the device owner.

For example, on obtaining the device, the device owner may specify a device identifier (e.g. a MAC address or UUID) to be included in the token.

As further example, the device owner may specify requirements for the token based on the resources on a device. For example, the device owner m[ay specify the location at which the device will primarily be used, the types of resources on the device (e.g. communications capabilities/security capabilities etc.). The token service can then configure the token based on or in response to the device specifications.

In some examples, the device owner may request that a token is generated before obtaining the device on which the token will subsequently provisioned. In such a scenario, the token service 46 will generate the token and include a device account identifier therein, but the device owner can subsequently request the token service to configure the token once the device is obtained. Additionally, or alternatively, the device owner may, e.g. via portal 45, configure data in the token.

The token service can configure data in each token in response to a request by another server/service at the device management platform. As an illustrative example, the bootstrap identifier may initially be set by the token service but reconfigured in response to a request from another server or service at the device management platform (e.g. for load balancing purposes).

The token is provisioned on the device 2 from the token service 46, whereby in the illustrative example of FIG. 3, and as depicted by S112a-112c, the token service 46 indirectly provisions the token to the device whereby the token is provisioned to the owner via portal 45, whereby the token is subsequently provisioned on the device 2 by the device owner. In another embodiment the token service 46 may directly provision the token on the device 2.

At S114 the device 2 initiates a bootstrap process with the bootstrap server 6 using the OEM certificate data and token, whereby the bootstrap server 6 determines whether the OEM certificate data presented by the device is to be trusted (e.g. by confirming that the certificate data presented by the device 2 corresponds to the OEM certificate previously registered at the device management platform), and further checks the legitimacy of the token. In an illustrative example, checking the legitimacy of the token may comprise bootstrap server 6, at S116, communicating with the token service 46 to verify that the device account identifier in the token matches an expected device account identifier and/or verifying authorisation data in the token.

For example, on receiving a token as part of a bootstrap request, the bootstrap server 30 can provide the token identifier to the token service 46. The token service 46 can then use the token identifier as an index to the database and compare the device account identifier in the token to the device account identifier stored in the database. When there is a match the token presented by the device is taken to be legitimate.

Additionally, or alternatively, the token service can use the token identifier and/or the device account identifier as an index to the database to identify a corresponding cryptographic key to verify the signature in the token or to decrypt encrypted data in the token. In an embodiment, the token service can send the corresponding cryptographic key to the bootstrap server to verify the signature and/or decrypt the data or the token service can perform the verification/decryption and provide confirmation to the bootstrap server. When the signature is verified and/or the encrypted data is decrypted, the token presented by the device is taken to be legitimate.

Additionally, or alternatively, the token service can use the token identifier as an index to the database to identify a device identifier to verify that the identifier of the device presenting the token matches the device identifier within the token and when there is a match, the token presented by the device is taken to be legitimate.

When the legitimacy of the token is successfully verified, at S118, the token service 46 confirms the successful verification.

When the legitimacy of the token is not/cannot be successfully verified the token service 46 may return an error and the bootstrap server will terminate the bootstrap process. The device owner may then be prompted to generate a valid token.

At S120 the bootstrap server 6 creates a device profile or entry (hereafter “device profile”) in a device directory 48 at the device management platform, whereby the device directory enables the device management platform to track all devices which have credential data to access on or more services thereat. The device profile may also include a list of the resources on the device 2 so that a server or service can access the resources on the device 2.

At S122, the bootstrap server 6 provisions a resource credential on the device 2, to enable the device 2 to, at S124, authenticate with the resource server 4, to access one or more services.

The resource credential may be based on or in response to device data in the token which provides information on one or more device resources and/or information relating to one more resource servers with which the device 2 is to authenticate as will be described in further detail below.

As an illustrative example, the device data in the token may specify that the device will primarily be used in a particular geographical location (e.g. UK). As such, the resource credential may comprise credential data to enable the device 2 authenticate with a server in the UK as opposed to a server in the US which would result in increased latency.

As a further illustrative example, the device data in the token may specify that the device has particular security capabilities. As such, the resource credential may comprise credential data to enable the device 2 authenticate with a server in accordance with the capabilities. For example, the device may not be capable of using public key cryptography to secure communications so the resource credential data provisioned on the device 2 may be for a resource server that can use symmetric key cryptography.

As a further illustrative example, the device data in the token may specify that the device has particular communication capabilities. As such, the resource credential may comprise credential data to enable the device 2 authenticate with a server in accordance with the capabilities. For example, the device may not be capable of using HTTP protocol so the resource credential data provisioned on the device 2 may be for a resource server that can use the CoAP protocol.

FIG. 4 illustratively shows an example process S200 in which a token service generates one or more tokens.

At S202, the device owner 44 requests, via portal 45, that one or more tokens are generated.

At S204, the request is forwarded to token service 46. At S206 the token service 46 generates and configures one or more tokens, and stores the tokens in a database thereat, each token having a device account identifier for an associated device account at the device management platform.

At S208, the token service confirms to the device owner (e.g. via portal 45) that the one or more tokens are created.

FIGS. 5a & 5b illustratively show an example process S300 in which device 2 is provisioned with credential data to enable the device 2 perform a bootstrap process.

At S302 the device owner 44 obtains a device from the OEM 42 and at S304 obtains OEM certificate in accordance with instructions. In an alternative embodiment the OEM certificate may be pre-provisioned on the device 2 when obtained by the device owner.

At S306 the device owner 44 uploads the OEM certificate to the device management platform via portal 45.

At S308 the portal 45 registers the OEM certificate as a trusted CA at the bootstrap server 6. At S310, the portal confirms to the device owner that the OEM certificate is registered as a trusted CA at the device management platform.

At S312 the device owner provisions OEM certificate data associated with the OEM certificate on the device. The OEM certificate data may comprise the certificate itself or a fingerprint or hash of the OEM certificate.

At S314, the device owner 44 requests, via portal 45, a token for the device 2, whereby at S316 the portal 45 forwards the request to the token server 46, which at S318 forwards a token to the device owner 44 in response to the request.

Each device owner may be authorised to have a specific number of tokens assigned to devices at any particular time. As such, the token service 46 may check whether the number of tokens assigned to devices for that device owner has reached a threshold device limit. When the threshold device limit is reached, the device owner may be prompted to de-assign one or more devices before a new token is issued to the device owner.

As above, in an illustrative example the token service may encrypt or sign some or all of the data in the token with a cryptographic key, such that only a server or service having access to a corresponding cryptographic key will be capable of decrypting the data and/or verifying the signature.

At S320 the device owner 44 provisions the token on the device 2, whereat the token is stored at S322, the token having inter alia the device account identifier and may further comprise an identifier for a bootstrap server (e.g. a bootstrap URI).

In embodiments the device owner may configure the data in the token. In an illustrative example, the owner may encrypt some or all of the data with a cryptographic key, such that only a server or service having a corresponding cryptographic key will be capable of decrypting the data.

FIG. 6 illustratively shows an example process S400 in which device 2 is provisioned with credential data to enable the device 2 to authenticate with a resource server 4.

At S402 the device 2 initiates a bootstrap process with bootstrap server 6 by transmitting the token as part of the bootstrap request. The device 2 also presents the certificate data to the bootstrap server 6 to enable the bootstrap server 6, at S404, determine whether the certificate data presented by the device is to be trusted (e.g. by confirming that the certificate data presented by the device 2 corresponds to the OEM certificate previously registered at the device management platform).

When the bootstrap server 6 successfully determines that that certificate data is to be trusted, the bootstrap server 6, at S406, communicates with the token service 46 to check the legitimacy of the token presented by the device 2.

When the legitimacy of the token is successfully verified, at S408, the token service 46 confirms the successful verification to the bootstrap server 6.

When the authenticity of the token is not/cannot be successfully verified (e.g. because the token does not exist; a signature does not match an expected signature; authorisation data cannot be decrypted) the token service 46 may return an error and the bootstrap server will terminate the bootstrap process. The device owner may then be prompted to (e.g. by the bootstrap server via portal 45) to obtain valid credential data such as a token.

In some embodiments the tokens may have a limited lifetime and expire after a period of time. For example, a token may expire if not claimed within 30 days, although the period may be any period dependent on device owner requirements. Once expired, a device presenting an expired token will be prompted to obtain a valid token.

At S410, the bootstrap server 6 requests that device directory 48 at the device management platform creates a device profile for the device 2, and at S412, the device directory 48 confirms that the device profile is created.

At S414, when the legitimacy of the token is successful verified, the bootstrap server 40 generates (or obtains) resource credential data to enable the device 2 to authenticate with the resource server 4, and at S416 provisions the resource credential data on the device 2.

At S418 the device 2 communicates with the resource server 4 using the resource credential data provisioned thereon, whereby the device 2 can access one or more services via the server 4 once the resource credential data is authenticated.

In embodiments a particular token may only be used in a bootstrap process by one device. In the case of a device being provisioned with a token but performing an unsuccessful bootstrap (e.g. due to termination of connection), that token cannot be used by any other device. The device 2 can then retry the bootstrap process with the same token without having to obtain a new token.

In embodiments a token may have a limited use e.g. one-time use, whereby when a device 2 successfully bootstraps with a bootstrap server to obtain resource credential data, the bootstrap server may notify the token service that the particular token (e.g. as identified by a token identifier) has been used and cannot be used again by the same or a different device.

In embodiments the bootstrap server 6 and/or device 2 may “clean-up” the records relating to the device 2, whereby such a clean-up may comprise deleting any previously stored resource credential data for the device from the device management platform.

As will be appreciated, and as depicted in the various Figures, communications between the various entities (e.g. device(s), server(s) service(s) may be secured in any suitable manner. For example, in FIGS. 4 and 5a-5b communications between the device owner 44 and the portal 45 may be secured using a session token or API key. Furthermore, as depicted in FIG. 6, communications between the portal 45 and token service 46 may be secured using a JSON web token (JWT token). It will be appreciated that depicted examples of securing communications between entities are exemplary only and the claims are not limited in this respect.

In a further related aspect, the present techniques provide a non-transitory data carrier carrying code which, when implemented on a processor, causes the processor to carry out the method described herein.

The techniques further provide processor control code to implement the above-described systems and methods, for example on a general purpose computer system or on a digital signal processor (DSP). The techniques also provide a carrier carrying processor control code to, when running, implement any of the above methods, in particular on a non-transitory data carrier—such as a disk, microprocessor, CD- or DVD-ROM, programmed memory such as read-only memory (firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1-23) (canceled)

24) A computer implemented method of bootstrapping a device by a bootstrap server, the method performed at the bootstrap server comprising:
receiving, from the device, credential data comprising a token and certificate data;
verifying, with a token service, whether the token is legitimate;
verifying, whether the certificate data is trusted;
responsive to verifying that the token is legitimate and that the certificate data is trusted providing, to the device, resource credential data to enable the device to register with a first server.

25) The method of claim 24, wherein the token comprises a device account identifier.

26) The method of claim 24, wherein the token comprises one or more of a device identifier, a bootstrap server identifier and authorisation data.

27) The method of claim 26, wherein the authorisation data comprises a cryptographic signature.

28) The method of claim 26, wherein the authorisation data comprises encrypted data.

29) The method of claim 24, wherein the token comprises device data to provide information on one or more device resources and/or information relating to one more servers.

30) The method of claim 29, wherein the device data specifies the geographical location at which the device will operate or one or more capabilities of the device.

31) The method of claim 24, wherein the certificate data comprises one or more of: a certificate and a certificate fingerprint to identify a corresponding certificate.

32) The method of claim 25, wherein verifying whether the token is legitimate;
comprises: communicating with the token service to check that the device account identifier matches an expected device account identifier.

33) The method of claim 27, wherein verifying whether the token is legitimate;
comprises: communicating with the token service to check that the cryptographic signature is verified.

34) The method of claim 28, wherein verifying whether the token is legitimate;
comprises: communicating with the token service to check that the encrypted data can be decrypted.

35) The method of claim 24, further comprising:
responsive to an unsuccessful verification, terminating the bootstrap process.

36) The method of claim 24, further comprising:
responsive to an unsuccessful verification, prompting the device to obtain valid credential data.

37) The method of claim 29, comprising:
generating the resource credential data based on or in response to the device data in the token.

38) The method of claim 24, wherein the token comprises a limited lifetime.

39) The method of claim 38, wherein the token is a one-time use token.

40) A computer implemented method of bootstrapping a device comprising:
obtaining, at the device from a device management platform, credential data comprising a token having a device account identifier;
providing, from the device to the bootstrap server, the token to enable the bootstrap server to determine the legitimacy of the token using a token service;
providing, from the device to the bootstrap server, certificate data to enable the bootstrap server to determine whether an associated certificate has a chain of trust to a trusted entity;
receiving, at the device from the bootstrap server, resource credential data to enable the device to register with a first server, the resource credential data based on or in response to the token.

41) A device comprising circuitry to perform the method of claim 40.

42) A computer implemented method of provisioning a device account identifier to a device, the method comprising:
receiving, at a device management platform, a certificate associated with a device account, the certificate having a chain of trust to a trusted party;
generating, at the device management platform, one or more tokens;
associating a first token of the one or more tokens with the device account;
provisioning, from the device management platform to the device; the first token;
receiving, at a bootstrap server of the device management platform from the device, a bootstrap request comprising credential data including the first token and certificate data;
verifying, with a token service at the device management platform, the legitimacy of the first token;
verifying, at the device management platform, using the certificate associated with the device account whether the certificate data is trusted;
responsive to a successful verification that the first token is legitimate and that the certificate data is trusted, providing, from the bootstrap server to the device, resource credential data to enable the device to register with a first server.

43) A non-transitory computer readable storage medium comprising code which when implemented on a processor causes the processor to carry out the method of claim 24.
